(19) United States
(12) Patent Application Publication
(10) Pub. No.: US 2003/0044699 A1
(43) Pub. Date: Mar. 6, 2003

(54) Check board replacement systems

(75) Inventor: Eric N. Nickles, Minneapolis, MN (US)

Correspondence Address: Honeywell International Inc., Law Dept. AB2, P.O. Box 2245, 101 Columbia Road, Morristown, NJ, 07962, US

(73) Assignee: Honeywell Advanced Circuits, Inc.

(21) Appl. No.: 09/941,417

(22) Filed: Aug. 28, 2001

(51) Int. Cl. G03C 5/00

(52) U.S. Cl. 430/30

(57) ABSTRACT

Methods for detection of defects introduced during processing within an exposure machine without the use of develop-etch-strip (“DES”) processed production layers. In particular, utilizing a “check board” that has different processing requirement than a production layer may significantly reduce the time and/or cost required for eliminating repetitive defects. A photoimagable MYLAR® (thin, strong, and polyester) sheet such as DuPont's CRONALAR hilight contact phototooling film may be advantageously used as the check board when producing printed wiring boards via DES processing.

### FIELD OF THE INVENTION

The field of the invention is photolithography methods and systems.

### BACKGROUND OF THE INVENTION

Creation of a finished printed wiring board often involves forming a conductive layer of a substrate into a specific pattern. In many instances the conductive layer starts out as a metal/conductive layer on a metal clad substrate. Forming the conductive layer into a specific pattern often involves coating the conductive layer with a photoimagable etch resist, transferring a pattern from production artwork onto the resist, and subsequently etching the conductive layer to form it into the pattern transferred from the production artwork. Once etching of the substrate is completed, automated optical inspection (“AOI”) systems may be used to verify the accuracy with which the pattern was reproduced on the substrate.

Transferring the pattern from the production art work onto the resist coating generally involves the use of a phototool/exposure machine. The production artwork is generally cleaned and set up in the exposure machine, and then a production layer is processed in the exposure machine. After processing in the exposure machine, the production layer is transferred to a develop-etch-strip (“DES”) machine for processing. In the DES machine, the resist layer is developed, the production layer is etched to remove unwanted/unprotected portions of metal layers, and residual resist is stripped from the production layer. After processing in the DES machine, the production layer is subjected to inspection and verification processes.

Whether or not it was heretofore realized, defects in the printed wiring board may be introduced during various stages of the production process such as during (a) creation of the original production artwork; (b) cleaning and setting up the production artwork in the exposure machine; (c) processing of the etch resist coated substrate in the exposure machine; and (d) processing of the exposed substrate in the DES machine. Defects introduced during stages (a) and (b) are generally repetitive in that they tend to recur in all of the production layers processed in an exposure machine after artwork is set up in the exposure machine. Since such errors tend to recur in all of the production layers subsequently processed, it is not uncommon to process a first layer to be used as a “checkboard”, and to inspect the “checkboard” for errors before processing any additional layers.

### SUMMARY OF THE INVENTION

The present invention is directed to the detection of defects introduced during processing within an exposure machine without the use of DES processed production layers. In particular, utilizing a “check board” that has different processing requirement than a production layer may significantly reduce the time required for eliminating repetitive defects. A photoimagable MYLAR® (thin, strong, and polyester) sheet such as DuPont's CRONALAR hilight contact phototooling film may be advantageously used as the check board.

In one embodiment, a claimed method includes: providing production artwork incorporating an image to be transferred to an imaged article via the exposure machine; installing the production artwork in an exposure machine to provide a configured exposure machine; utilizing the configured exposure machine to produce a first imaged article; inspecting and verifying the first imaged article; and utilizing the configured exposure machine to produce a second imaged article; wherein the time and/or cost required to produce the second imaged article is less than that to produce the first imaged article.

It is contemplated that the claimed invention provides for check board production without requiring the use of DES methods, allows check board production to occur in a lit area rather than in a dark room, and allows check board processing, inspection, and verification to occur in the same room as an exposure machine so that errors in exposure machine setup can be corrected without transporting material or people to another area.

Various objects, features, aspects and advantages of the present invention will become more apparent from the following detailed description of preferred embodiments of the invention, along with the accompanying drawings in which like numerals represent like components.

### BRIEF DESCRIPTION OF THE DRAWINGS

FIG. 1 is a diagram of a first method embodying the invention.

FIG. 2 is a diagram of a second method embodying the invention.

### DETAILED DESCRIPTION

As disclosed herein, the claimed methods eliminate the need to use DES processing to eliminate errors introduced into DES processed items where such errors are the result of errors introduced during production artwork creation, or introduced during the set up of such production artwork in an exposure machine to provide a configured exposure machine. Elimination of the need to use DES processed items is accomplished by using the configured exposure machine to create a first imaged article (a “check board”) such as a phototooling film that can be processed, inspected, and verified more quickly, and/or more cheaply than a second imaged article such as a DES processed printed wiring board. It is contemplated that the disclosed methods are particularly advantageous when a photoimagable MYLAR® sheet is used in place of a copper clad laminate as the check board.

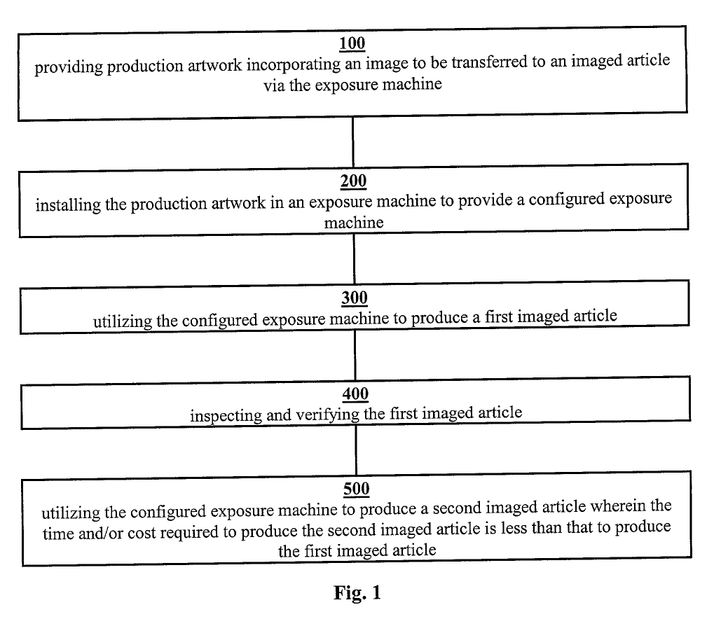

Referring to FIG. 1, a preferred verification process includes step 100, providing production artwork incorporating an image to be transferred; step 200, installing the production artwork in an exposure machine to provide a configured exposure machine; step 300, utilizing the configured exposure machine to produce a first imaged article; step 400, inspecting and verifying the first imaged article; step 500, utilizing the configured exposure machine to produce a second imaged article wherein the time and/or cost required to produce the second imaged article is less than that of the first imaged article.

Step 100, providing production artwork incorporating an image to be transferred may be accomplished in any of a number of known ways. One of average skill in the art will realize that any suitable means for providing production artwork may be used with the claimed methods. Such suitable means may include, but are not necessarily limited to CAD driven laser plotting.

Step 200, installing the production artwork in an exposure machine to provide a configured exposure machine typically involves washing the production artwork, washing the exposure frame glass, and tacky cleaning both surfaces with a hand-held tacky roller. The actions taken during this step of the processing are frequently the source of errors in the final product. As with step 100, any suitable means for accomplishing this step may be utilized.

Step 300, utilizing the configured exposure machine to produce a first imaged article may be accomplished in any of a number of known ways. One of average skill in the art will realize that any suitable means for utilizing the configured exposure machine to produce a first imaged article may be used with the claimed methods. Such suitable means may include, but are not necessarily limited to processing a production layer through subsequent processes to yield an image to be scanned and verified.

It is important that the first imaged article/check board be more quickly produced, inspected, and/or verified than the articles to be produced once the disclosed methods are used to eliminate repetitive errors. As such, it is preferred that the check board be formed from a negative-working silver halide contacting film designed to make reversed tone reproductions in contact frames utilizing high-intensity ultra-violet lamps which can be handled under ultra-violet filtered white or yellow lights. It is contemplated that the use of such a film provides numerous benefits that are not available when production layers are used as check boards. One such is that the check board can be processed in a white (albeit ultra-violet filtered) light rather than in a dark room setting. Another is that there is no etching or stripping process involved. Yet another is that the check board be processed, inspected, and verified within the same room that the exposure machine is located in to eliminate any time lost transferring the check board. Still another is that DES productivity will not be interrupted. Also, AOI department productivity will not be interrupted. Although a silver halide contacting film is preferred, it should be noted that alternative materials/articles may be used in producing the first check board so long as the article can be produced, inspected, and/or verified more quickly or with less cost than a DES processed article.

Step 400, inspecting and verifying the first imaged article may be accomplished in any of a number of known ways. One of average skill in the art will realize that any suitable means for inspection and verification may be used with the claimed methods. Such suitable means may include, but are not necessarily limited to automated optical inspection machines and manual verification with stereoscopes.

Step 500, utilizing the configured exposure machine to produce a second imaged article may be accomplished in any of a number of known ways. One of average skill in the art will realize that any suitable means for utilizing the configured exposure machine to product a second imaged article may be used with the claimed methods. Such suitable means may include, but are not necessarily limited to processing a production layer through subsequent processes to yield an image to be scanned and verified.

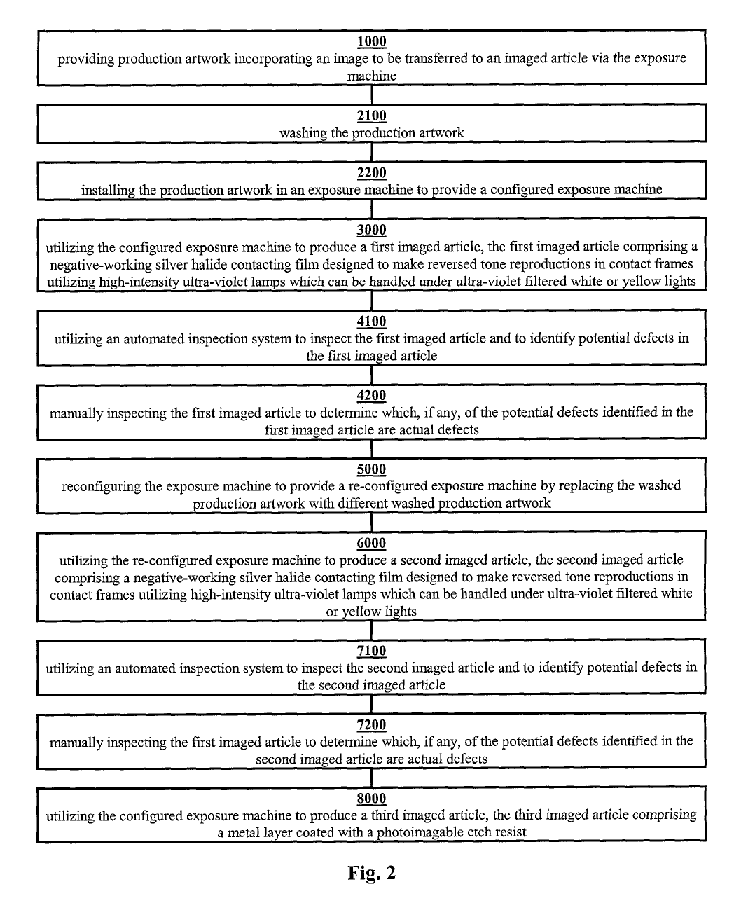

Referring to FIG. 2, an embodiment of the process of FIG. 1 includes: step 1000, providing production artwork incorporating an image to be transferred to an imaged article via the exposure machine; step 2100, washing the production artwork; step 2200, installing the production artwork in an exposure machine to provide a configured exposure machine; step 3000, utilizing the configured exposure machine to produce a first imaged article, the first imaged article comprising a negative-working silver halide contacting film designed to make reversed tone reproductions in contact frames utilizing high-intensity ultra-violet lamps which can be handled under ultra-violet filtered white or yellow lights; step 4100, utilizing an automated inspection system to inspect the first imaged article and to identify potential defects in the first imaged article; step 4200, manually inspecting the first imaged article to determine which, if any, of the potential defects identified in the first imaged article are actual defects; step 5000, reconfiguring the exposure machine to provide a re-configured exposure machine by replacing the washed production artwork with different washed production artwork; step 6000, utilizing the re-configured exposure machine to produce a second imaged article, the second imaged article comprising a negative-working silver halide contacting film designed to make reversed tone reproductions in contact frames utilizing high-intensity ultra-violet lamps which can be handled under ultra-violet filtered white or yellow lights; step 7100, utilizing an automated inspection system to inspect the second imaged article and to identify potential defects in the second imaged article; step 7200, manually inspecting the first imaged article to determine which, if any, of the potential defects identified in the second imaged article are actual defects; step 8000, utilizing the configured exposure machine to produce a third imaged article, the third imaged article comprising a metal layer coated with a photoimagable etch resist wherein the time and cost required to produce the first imaged article is substantially equal to the time and cost required to produce the second imaged article, and the time or cost to produce the third imaged article is substantially less than that to produce the first imaged article.

Thus, specific embodiments and applications of methods for producing imaged articles have been disclosed. It should be apparent, however, to those skilled in the art that many more modifications besides those already described are possible without departing from the inventive concepts herein. The inventive subject matter, therefore, is not to be restricted except in the spirit of the appended claims. Moreover, in interpreting both the specification and the claims, all terms should be interpreted in the broadest possible manner consistent with the context. In particular, the terms “comprises” and “comprising” should be interpreted as referring to elements, components, or steps in a non-exclusive manner, indicating that the referenced elements, components, or steps may be present, or utilized, or combined with other elements, components, or steps that are not expressly referenced.

What is claimed is:

1. A method for producing imaged articles comprising:
providing production artwork incorporating an image to be transferred to an imaged article via the exposure machine;
installing the production artwork in an exposure machine to provide a configured exposure machine;
utilizing the configured exposure machine to produce a first imaged article;
inspecting and verifyng the first imaged article; and
utilizing the configured exposure machine to produce a second imaged article;
wherein the time and/or cost required to produce the second imaged article is less than that to produce the first imaged article.

2. The method of claim 1 wherein the second imaged article is structurally different from the first imaged article.

3. The method of claim 2 wherein the second imaged articled is a substrate comprising a metal layer coated with a photoimagable etch resist.

4. The method of claim 3 wherein the first imaged article is a phototooling film.

5. The method of claim 4 wherein the first imaged article is a negative-working silver halide contacting film designed to make reversed tone reproductions in contact frames utilizing high-intensity ultra-violet lamps which can be handled under ultraviolet filtered white or yellow lights.

6. The method of claim 1 wherein the production artwork is cleaned prior to being installed in the exposure machine.

7. The method of claim 1 wherein the configuration of the exposure machine is reconfigured after producing the first imaged article, and the re-configured exposure machine is used to produce a third imaged article prior to being used to produce the second imaged article; and wherein the time and/or cost required to produce each of the first and third imaged articles is/are substantially equal.

8. The method of claim 7 wherein each of the first imaged article and the third imaged article is a negative-working silver halide contacting film designed to make reversed tone reproductions in contact frames utilizing high-intensity ultra-violet lamps which can be handled under ultra-violet filtered white or yellow lights.

9. A method for producing imaged articles comprising:
providing production artwork incorporating an image to be transferred to an imaged article via the exposure machine;
washing the production artwork;
installing the production artwork in an exposure machine to provide a configured exposure machine;
utilizing the configured exposure machine to produce a first imaged article, the first imaged article comprising a negative-working silver halide contacting film designed to make reversed tone reproductions in contact frames utilizing high-intensity ultra-violet lamps which can be handled under ultra-violet filtered white or yellow lights;
utilizing an automated inspection system to inspect the first imaged article and to identify potential defects in the first imaged article;
manually inspecting the first imaged article to determine which, if any, of the potential defects identified in the first imaged article are actual defects;
reconfiguring the exposure machine to provide a re-configured exposure machine by replacing the washed production artwork with different washed production artwork;
utilizing the re-configured exposure machine to produce a second imaged article, the second imaged article comprising a negative-working silver halide contacting film designed to make reversed tone reproductions in contact frames utilizing high-intensity ultra-violet lamps which can be handled under ultra-violet filtered white or yellow lights;
utilizing an automated inspection system to inspect the second imaged article and to identify potential defects in the second imaged article;
manually inspecting the first imaged article to determine which, if any, of the potential defects identified in the second imaged article are actual defects; and
utilizing the configured exposure machine to produce a third imaged article, the third imaged article comprising a metal layer coated with a photoimagable etch resist.
